(19) United States
(12) Patent Application Publication
(10) Pub. No.: US 2022/0289582 A1
(43) Pub. Date: Sep. 15, 2022

(54) Power Augmentation for a Gas Turbine

(71) Applicants: John Skaanderup-Larsen, Santa Fe, TX (US); Keith Gaylon King, Cypress, TX (US)

(72) Inventors: John Skaanderup-Larsen, Santa Fe, TX (US); Keith Gaylon King, Cypress, TX (US)

(73) Assignee: KELLOG BROWN & ROOT LLC, Houston, TX (US)

(21) Appl. No.: 17/200,370

(22) Filed: Mar. 12, 2021

(51) Int. Cl. C01C 1/04; F02C 6/10; F02C 6/08; B01J 19/24; C01B 3/32; C01B 3/02

(52) U.S. Cl. CPC C01C 1/0417; F02C 6/10; F02C 6/08; B01J 19/245; C01B 3/32; C01B 3/025; F05D 2220/32; C01B 2203/0205; C01B 2203/068

(57) ABSTRACT

Systems and methods for improving the efficiency of plants that use a gas turbine engine to power a process air compressor are disclosed. Examples of such plants include ammonia production plants, wherein a gas turbine engine is used to power a process air compressor and wherein exhaust gas from the gas turbine engine is provided as combustion gas to a reformer furnace. The increase in efficiency is provided using a booster compressor to enhance the performance of the gas turbine engine. According to some embodiments, the booster compressor may also be used to reduce the power consumption of the process air compressor. According to some embodiments, a side stream from the booster compressor may be provided to the furnace to supplement the combustion gas provided by the gas turbine engine exhaust gas. The disclosed methods and systems increase the efficiency of the plant while maintaining the duty balance between the furnace and the process air compressor-driven process.

### CROSS REFERENCE TO RELATED APPLICATIONS

The present application claims priority to U.S. Provisional Patent Application Ser. No. 62/991,857, filed Mar. 19, 2020, the contents of which are incorporated herein by reference.

### FIELD OF THE INVENTION

This application relates to boosting the power of a gas turbine, and more particularly, to augmenting a gas turbine used in an ammonia production plant.

### INTRODUCTION

Gas turbines are often used for energy generation, for example, to drive an electric generator, as illustrated schematically in FIG. 1A. For energy generation, compressed air and fuel are combusted and the combustion gas is used to provide rotational power that drives the electric generator. The hot turbine exhaust gas is often provided to a waste heat recovery system in an attempt to increase the efficiency of the overall system, for example, by using the heat of the exhaust to generate steam to provide further work, such as powering steam turbines or the like. This use of the exhaust can be seen as remedial, i.e., it is an attempt to mitigate the fact that the gas turbine lacks efficiency. For electric generation, the higher the efficiency of the turbine, the better. In other words, we would like to have a turbine that produces the maximum rotational power (for driving a generator) with the least amount of hot exhaust production. In a perfect (but unobtainable) world, all of the combustion energy would be converted to rotational power and no hot exhaust would be produced. That consideration has driven gas turbine development over the past decades, resulting in gas turbines that are highly efficient (e.g., about 60%), due to advances in materials and design.

Gas turbines can also be used to drive equipment, such as compressors, for example in certain petrochemical processes/plants. One example is schematically illustrated in FIG. 1B. In the illustrated example, the gas turbine provides rotational power to drive a compressor, which provides reactant, such as process air to a reactor. The exhaust gas of the turbine is used to provide combustion air to a reforming furnace, which in the illustrated example, is used for a reformer. An example of such a process is a Haber-Bosch ammonia process, and specifically, the Purifier™ process owned by the assignee of the instant application, which is discussed in more detail below.

Notice that in the system illustrated in FIG. 1B, the exhaust gas is not simply an inefficiency that must be dealt with; it is an integral part of the process. The capacity of the furnace must be balanced with the size of the compressor, which is determined by the requirement of the reactor capacity. If the gas turbine is too efficient (i.e., it does not provide adequate exhaust to run the furnace), the overall process suffers because the furnace and the compressor are out of balance. There is a need in the art for boosting the power output of a gas turbine that is used to drive a compressor in a process, such as illustrated in FIG. 1B. However, simply using a more efficient gas turbine is not the optimal solution, for the reasons discussed above.

### SUMMARY

Disclosed herein is a chemical processing plant comprising: a furnace, a process compressor, a gas turbine engine configured to drive the process compressor, wherein the gas turbine engine generates an exhaust gas, and wherein at least a portion of the exhaust gas is provided to the furnace as combustion air for the furnace, and a booster compressor configured to provide compressed air to the gas turbine engine (for example, to a turbo compressor of the gas turbine engine). According to some embodiments, the booster compressor is further configured to provide compressed air to the process compressor. According to some embodiments, the booster compressor is further configured to provide compressed air to the furnace. According to some embodiments, the booster compressor is further configured to provide compressed air to the process compressor and to the reforming furnace. According to some embodiments, the booster compressor is powered by an electric motor. According to some embodiments, the booster compressor is powered by a steam turbine. According to some embodiments, the chemical processing plant further comprises an intercooler configured to cool the compressed air provided by the booster compressor to the turbo compressor of the gas turbine engine and to the process compressor. According to some embodiments, the furnace is a reforming furnace configured to convert hydrocarbon in the presence of steam and a combustion gas to form syngas, and wherein the combustion gas comprises the exhaust gas of the gas turbine engine. According to some embodiments, the process compressor is configured to provide the compressed air feed to an ammonia process. According to some embodiments, providing compressed air feed to an ammonia process comprises providing compressed air to a secondary reformer.

Also disclosed herein is an ammonia synthesis system comprising: a reforming furnace configured to convert natural gas in the presence of steam and a combustion gas to form syngas, an ammonia process configured to react hydrogen from the syngas with nitrogen from a process air feed to form ammonia, a process compressor configured to provide the process air feed to the ammonia process, a gas turbine engine configured to drive the process compressor and to generate an exhaust gas, wherein the gas turbine engine comprises a turbo compressor, a combustor, and a power turbine, and a booster compressor configured to provide compressed air to the turbo compressor of the gas turbine engine, wherein at least a portion of the exhaust gas of the gas turbine engine is provided to the reforming furnace to provide at least a portion of the combustion gas. According to some embodiments, the booster compressor is further configured to provide compressed air to the process compressor. According to some embodiments, the booster compressor is further configured to provide compressed air to the reforming furnace. According to some embodiments, the booster compressor is further configured to provide compressed air to the process compressor and to the reforming furnace. According to some embodiments, the booster compressor is powered by an electric motor. According to some embodiments, the booster compressor is powered by a steam turbine. According to some embodiments, the system further comprises an intercooler configured to cool the compressed air provided by the booster compressor to the turbo compressor of the gas turbine engine.

Also disclosed herein is a method of increasing the capacity of an ammonia-producing system, wherein the ammonia-producing system comprises: a reforming furnace configured to convert natural gas in the presence of steam to form syngas, an ammonia reactor configured to react hydrogen from the syngas with nitrogen from a compressed air feed to form ammonia, a process compressor configured to provide the compressed air feed to the system, and a gas turbine engine configured to drive the process compressor and to generate an exhaust gas, wherein the gas turbine engine comprises a turbo compressor, a combustor, and a power turbine, and is configured so that at least a portion of the exhaust gas of the gas turbine engine is provided to the reforming furnace to provide at least a portion of the combustion gas, and wherein the method comprises: using a booster compressor configured to provide compressed air to the turbo compressor of the gas turbine engine. According to some embodiments, the booster compressor provides compressed air to the process compressor. According to some embodiments, the booster compressor provides compressed air to the reforming furnace. According to some embodiments, the booster compressor provides compressed air to the process compressor and to the reformer furnace. According to some embodiments, the booster compressor is powered by an electric motor. According to some embodiments, the booster compressor is powered by a steam turbine. According to some embodiments, an intercooler is configured to cool the compressed air provided by the booster compressor to the turbo compressor of the gas turbine engine.

### BRIEF DESCRIPTION OF THE DRAWINGS

FIGS. 1A and 1B show the use of a gas turbine engine for driving an electric generator and a process compressor, respectively.

FIG. 2 shows an ammonia processing plant having a gas turbine engine for driving a process compressor.

FIG. 3 shows an embodiment of an ammonia plant with increased capacity.

FIG. 4 shows a further embodiment of an ammonia plant with increased capacity.

FIG. 5 shows a further embodiment of an ammonia plant with increased capacity.

FIG. 6 shows a further embodiment of an ammonia plant with increased capacity.

### DETAILED DESCRIPTION

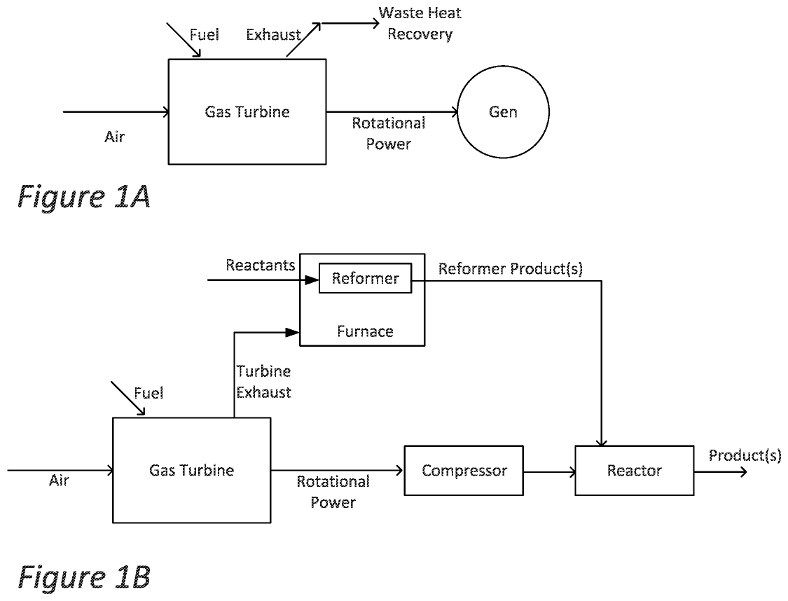

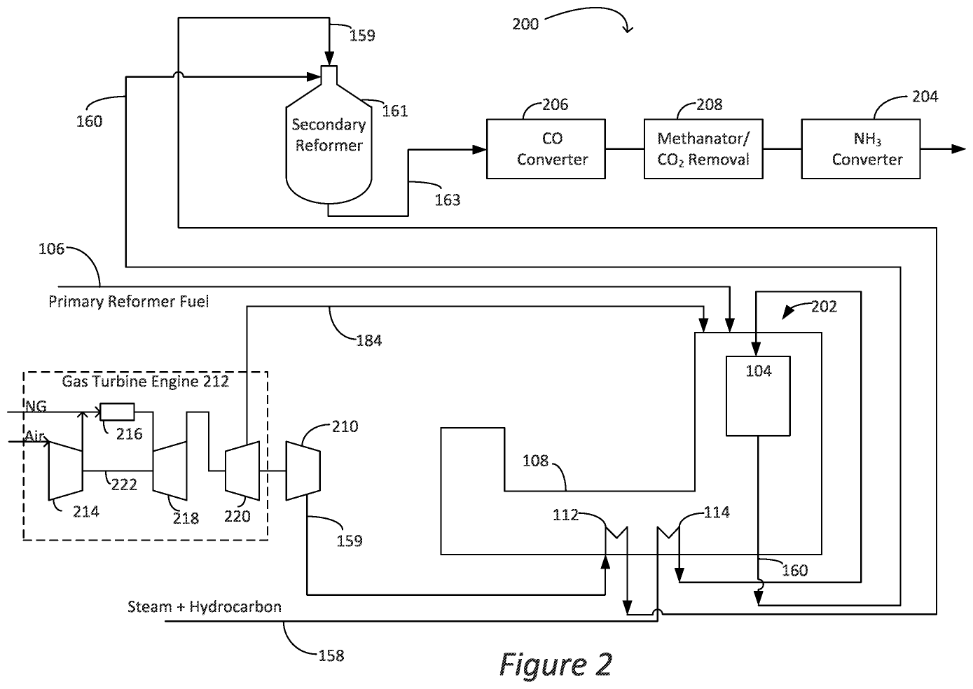

FIG. 2 provides a more detailed illustration of an example process 200, such as the one illustrated in FIG. 1B. Specifically, FIG. 2 illustrates aspects of an ammonia plant in which natural gas is used as a feed stock to produce ammonia. It will be noted that an actual ammonia plant includes various other process steps that are not relevant to this disclosure and so are not discussed.

In the illustrated process 200, steam and natural gas (or other suitable hydrocarbon, such as naphtha) are reacted in a steam reforming furnace 202 to produce syngas (a mixture of carbon monoxide (CO) and hydrogen (H₂)). Fuel may be provided to the furnace 202 via line 106. The steam reforming furnace 202 contains catalyst tubes 104 where steam and hydrocarbons are heated to produce a syngas. The syngas leaves the catalyst tubes and is passed to the secondary reformer 161 via 160. The steam and hydrocarbon mixture (line 158) is typically preheated before entering the reformer catalyst tube and here one preheat coil is shown as 114, located in the convection section 108 of the reformer 202. In a similar manner, the process air for the secondary reformer (line 159) is typically preheated in one or more preheat coils located in the convection section of the primary reformer. One such coil 112 is shown. After preheating the process air is passed to the secondary reformer via pipe 159. The effluent of the steam reforming furnace enters a secondary reformer 161 where it reacts with process air from a process compressor 210 to form more syngas. The resulting syngas stream 163 is treated in various processes to ultimately provide H₂ and N₂ to an ammonia converter 204. For example, the syngas may be reacted in a carbon monoxide converter 206, which converts the carbon monoxide to carbon dioxide (CO₂) and provides more H₂. The resulting gas stream may also be treated by one or more CO₂ removal steps and/or methanation steps 208, which remove CO₂ from the stream. Steps 206 and 208 are not particularly relevant to this disclosure and so are not discussed further.

The H₂ obtained from the syngas reacts with compressed nitrogen (N₂) in the ammonia converter 204 to produce ammonia (NH₃). The ammonia converter includes a catalyst, which is typically an iron-based catalyst but may alternatively or additionally include other metal compounds, such as ruthenium compounds. A process compressor 210 provides the compressed N₂ for the ammonia reaction. The process compressor 210 is typically a centrifugal compressor and is powered by a gas turbine engine 212, which is discussed below.

The gas turbine engine 212 comprises a turbo compressor 214, a combustor 216, a high-pressure turbine 218, a power turbine 220, and a shaft 222. Examples of gas turbine engines such as 212 are known in the art and include Frame 5 gas turbine engines such as MS5001/5002 series turbines (General Electric), MS6001 series turbines (General Electric), and the like. It should be appreciated that the disclosed methods and systems are not limited to any particular type of gas turbine engine. As mentioned above, power from the gas turbine engine 212 is provided to power the process compressor 210. As also mentioned, the turbine exhaust gas of the gas turbine engine 184 is provided as combustion gas for the reforming furnace 202. In other words, the oxygen remaining in the turbine exhaust gas is used as feed for the combustion process occurring in the reforming furnace.

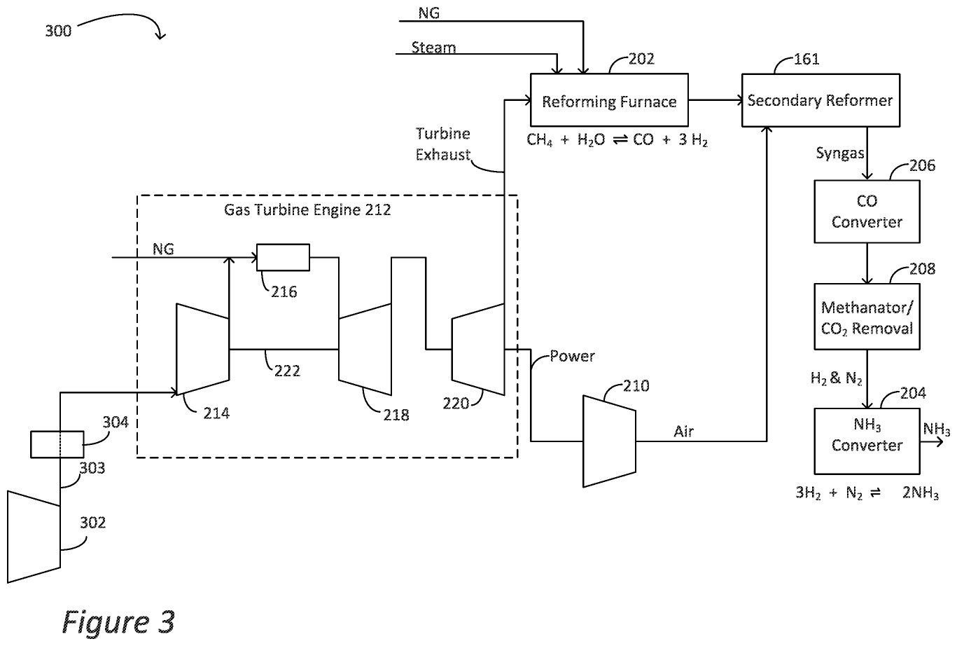

To increase the production of NH₃, it is desirable to increase the capacity of the process compressor 210. As mentioned in the Introduction section above, simply providing a more efficient gas turbine engine is not a good solution for increasing the capacity of the process compressor in many instances, because super-high efficiency turbine engines lack the capacity to supply sufficient combustion air for the reforming furnace 202. In other words, the duty of the reforming furnace must be balanced with the capacity of the process compressor driving the ammonia reaction. The inventor has discovered that power to the process compressor 210 can be increased by the addition of a booster compressor 302, as shown in the improved ammonia process 300 illustrated in FIG. 3. According to preferred embodiments, the booster compressor is independent of the shaft 222 of the gas turbine engine 212, and so can be run at a speed independent of the gas turbine engine. For example, the booster compressor 302 can be driven by a steam turbine or an electric motor. In the case that a steam turbine is used, the steam turbine driver can be driven by process waste steam. The booster compressor 302 may be a multistage compressor, for example, a two or three stage compressor.

Air from the booster compressor 302 is provided to the turbo compressor 214 (line 303) of the gas turbine engine 212. The air from the booster compressor 302 may be cooled using an optional intercooler 304, depending on the amount of boost needed. Providing air from the booster compressor to the turbo compressor 214 unloads the gas turbine engine 212, allowing it to run at a different speed to satisfy the need of the process compressor 210. The booster compressor 302 also increases the mass flow through the gas turbine engine 212. Thus, the amount of turbine exhaust gas provided to the reforming furnace 202 is increased. So, the addition of the booster compressor 302 not only increases the capacity of the process compressor 210; it also increases the capacity of the reforming furnace 202.

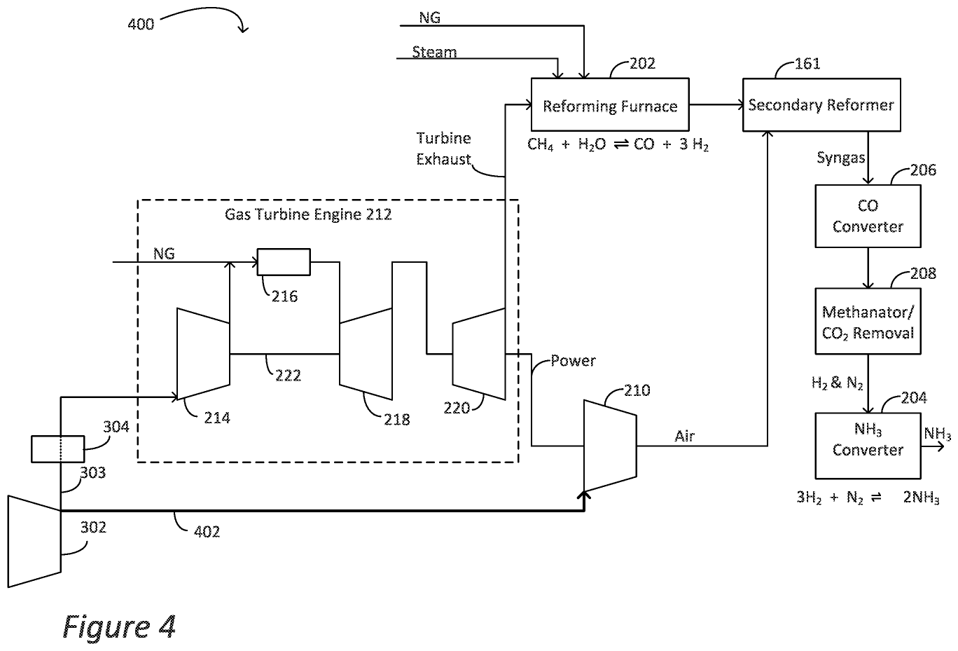

FIG. 4 illustrates an alternative embodiment of an ammonia process 400, wherein air from the booster compressor 302 is supplied to the process compressor 210 (illustrated by line 402) in addition to being supplied to the turbo compressor of the gas turbine engine. Thus, the booster compressor boosts both the gas turbo compressor and the process compressor. Supplying air from the booster compressor 302 to the suction of the process compressor 210 reduces the power requirement of the process compressor, thereby reducing the power requirement of the gas turbine engine 212. It is thus possible to satisfy a much wider range of plant capacities with any given gas turbine engine, since the booster compressor enhances the performance of the gas turbine engine. Note that in the illustrated process 400, the air from the booster compressor (line 402) is not cooled. However, according to some embodiments, the booster compressor air could be cooled before it is provided to the process compressor. For example, the air stream 402 could be taken downstream of the intercooler 302.

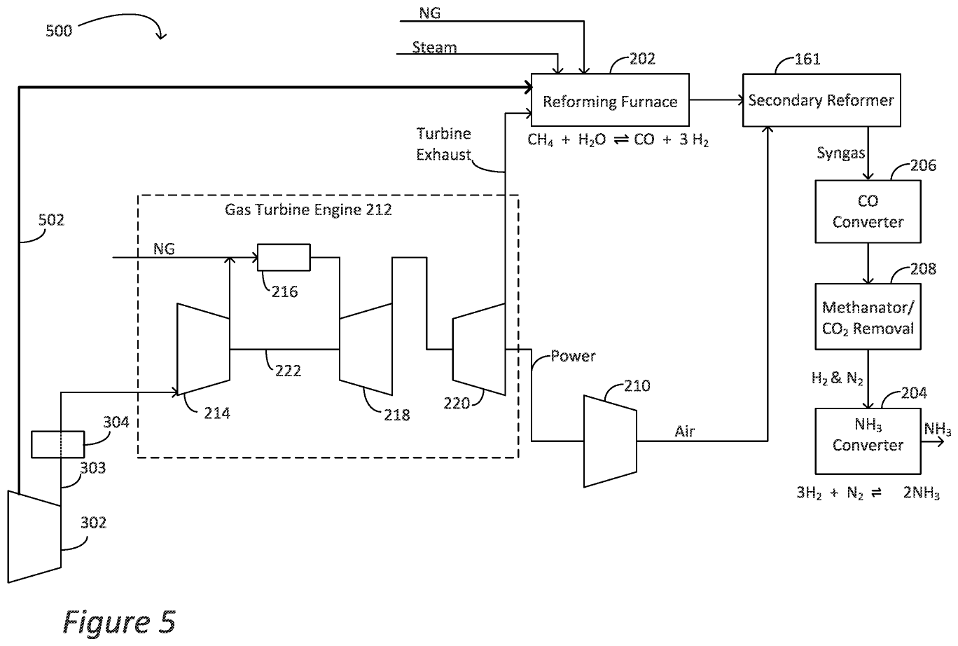

FIG. 5 illustrates another alternative embodiment of an ammonia process 500, in which compressed air from the booster compressor 302 (line 502) is provided as combustion air to the reforming furnace 202, in addition to being supplied to the turbo compressor. According to some embodiments, the air stream 502 may be taken after an intermediate stage of the booster compressor, for example, after the first stage. Using the booster compressor 302 to supply combustion air to the reforming furnace 202 in a case where the gas turbine exhaust is not satisfying the reformer furnace has the benefit of eliminating the need to install a combustion air fan for the reforming furnace.

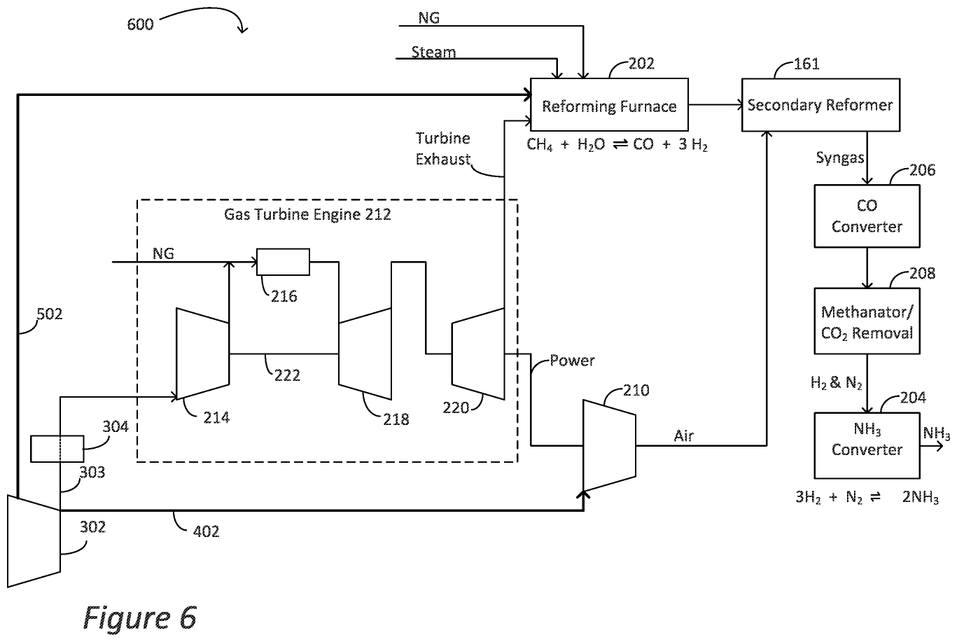

FIG. 6 illustrates another embodiment of an ammonia process 600, wherein the booster compressor 302 provides air to the process compressor 210 (line 402) and combustion air to the reforming furnace 202 (line 502) in addition to supplying air to the turbo compressor 214. The embodiment illustrated in FIG. 6 is essentially a combination of the embodiments of FIGS. 4 and 5.

It should be noted, that while the embodiments described herein are described in the context of an ammonia process, the concept of using a booster compressor to offload a gas turbine engine can be implemented in other processes in which the turbine engine is used to power a compressor.

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A chemical processing plant comprising:
a furnace,
a process compressor,
a gas turbine engine configured to drive the process compressor, wherein the gas turbine engine generates an exhaust gas, and wherein at least a portion of the exhaust gas is provided to the furnace as combustion air, and
a booster compressor configured to provide compressed air to a turbo compressor of the gas turbine engine.

2. The chemical processing plant of claim 1, wherein the booster compressor is further configured to provide compressed air to the process compressor.

3. The chemical processing plant of claim 2, further comprising an intercooler configured to cool the compressed air provided by the booster compressor to the turbo compressor of the gas turbine engine.

4. The chemical processing plant of claim 1, wherein the booster compressor is further configured to provide compressed air to the furnace.

5. The chemical processing plant of claim 1, wherein the booster compressor is further configured to provide compressed air to both the process compressor and to the reforming furnace.

6. The chemical processing plant of claim 1, wherein the booster compressor is powered by an electric motor.

7. The chemical processing plant of claim 1, wherein the booster compressor is powered by a steam turbine.

8. The chemical processing plant of claim 2, further comprising an intercooler configured to cool the compressed air provided by the booster compressor to the turbo compressor of the gas turbine engine and to the process compressor.

9. The chemical processing plant of claim 1, wherein the furnace is a furnace of a primary reformer configured to convert hydrocarbon in the presence of steam to form syngas.

10. The chemical processing plant of claim 1, wherein the process compressor is configured to provide compressed air feed to an ammonia process.

11. The chemical processing plant of claim 10, wherein providing compressed air feed to an ammonia process comprises providing compressed air to a secondary reformer.

12. An ammonia synthesis system comprising:
a reformer comprising a furnace, wherein the reformer is configured to convert natural gas in the presence of steam to form syngas,
an ammonia process configured to react hydrogen from the syngas with nitrogen from a process air feed to form ammonia,
a process compressor configured to provide the process air feed to the ammonia process,
a gas turbine engine configured to drive the process compressor and to generate an exhaust gas, wherein the gas turbine engine comprises a turbo compressor, a combustor, and a power turbine, and
a booster compressor configured to provide compressed air to the turbo compressor of the gas turbine engine, wherein
at least a portion of the exhaust gas of the gas turbine engine is provided to the furnace to provide combustion air for the furnace.

13. The system of claim 12, wherein the booster compressor is further configured to provide compressed air to the process compressor.

14. The system of claim 12, wherein the booster compressor is further configured to provide compressed air to the furnace.

15. The system of claim 12, wherein the booster compressor is further configured to provide compressed air to the process compressor and to the furnace.

16. The system of claim 12, wherein the booster compressor is powered by an electric motor.

17. The system of claim 12, wherein the booster compressor is powered by a steam turbine.

18. The system of claim 12, further comprising an intercooler configured to cool the compressed air provided by the booster compressor to the turbo compressor of the gas turbine engine.

19. A method of increasing the capacity of an ammonia-producing system, wherein the ammonia-producing system comprises:
a reformer comprising a furnace, wherein the reformer is configured to convert natural gas in the presence of steam to form syngas,
an ammonia reactor configured to react hydrogen from the syngas with nitrogen from a compressed air feed to form ammonia,
a process compressor configured to provide the compressed air feed to the ammonia reactor, and
a gas turbine engine configured to drive the process compressor and to generate an exhaust gas, wherein the gas turbine engine comprises a turbo compressor, a combustor, and a power turbine, and is configured so that at least a portion of the exhaust gas of the gas turbine engine is provided to the furnace to provide combustion air for the furnace, the method comprising:
using a booster compressor configured to provide compressed air to the turbo compressor of the gas turbine engine.

20. The method of claim 19, further comprising using the booster compressor to provide compressed air to one or more of the process compressor and the furnace.
